(19) United States
(12) Patent Application Publication
(10) Pub. No.: US 2003/0037507 A1
(43) Pub. Date: Feb. 27, 2003

(54) Building structure with LSL core

(75) Inventor: David L. Weza, Eugene, OR (US)

Correspondence Address: STOEL RIVES LLP, 900 SW FIFTH AVENUE, SUITE 2600, PORTLAND, OR, 97204, US

(73) Assignee: Rosboro Lumber Company, Springfield, OR

(21) Appl. No.: 10/228,801

(22) Filed: Aug. 26, 2002

Related U.S. Application Data
(60) Provisional application No. 60/315,270, filed on Aug. 27, 2001.

(51) Int. Cl. E04C 3/30; E04C 2/54; E06B 1/04; E04C 2/00

(52) U.S. Cl. 52/730.7; 52/782.1; 52/211

(57) ABSTRACT

A building structure such as, for example, a door or window jamb, is provided having outer solid wood members secured together around a LSL core which provides uniform moisture and density and which remains within dimensional and tolerance requirements. The multi-directional placement of wood fibers in the LSL core allows for a uniform binding of wood composite components to all flat surfaces and allows for any change in moisture content causing shrinkage or swelling in all directions reducing twisting or cupping. The LSL core provides a product that has a lesser weight per volume and is easier to handle and move to the point of installation within the building. The multi-directional fibers of the LSL core further provides greater screw holding capabilities and carrying ability than prior core products.

### TECHNICAL FIELD

This invention relates generally to building structures such-as, for example, doors, relite frames, door/relite jambs, door/relite mullions, stile/rail doors and wall caps. More specifically, the invention relates to building product containing a LSL core.

### BACKGROUND OF THE INVENTION

In the construction of buildings and, more particularly, the construction of institutional and commercial buildings it is common and sometimes necessary to include interior room and space wall openings and window framing. The openings for doors and windows are usually first roughly framed in with wall studs. A door or window jamb assembly or other door or window structure is then added and structures are then finished to provide an attractive appearance.

These structures are typically made up of outer solid wood segments attached together around a central core. It has been found that a central core of solid wood is not cost effective and also adds to the weight of the structure. However, it is desirable to have a central core that is strong and that provides dimensional stability as well as having the capacity to secure fasteners such as, for example, nails and screws. Therefore, a soft wood component is typically used as the central core. In the past, soft wood components included plywood panels glued together to a certain desired thickness and then ripped to various lengths to form a blank which was then processed by milling or routing to form a finished central core. However, plywood panel central cores do not provide the desired stability. More specifically, glued plywood panels often have adhesion problems between the plywood panels because the amount of pressure required to achieve adequate bonding of the plywood panel surfaces is often inadequate. Additionally, adhesion problems occur because of improper preparation of the gluing surfaces. Furthermore, cupping problems occur due to moisture which often affects the outer sides more than the middle of the plywood causing the outer sides to swell resulting in a curved or cupped shaped. One of the reasons for cupping is that with plywood panels the wood fibers are directional or extend in primarily one direction.

One effort to overcome the problems associated with using a plywood panel central core included the use of LVL or laminated veneer lumber. Although LVL was more cost effective it still had problems such as, for example, cupping. Similar to plywood panels the wood fibers in LVL are also directional.

What is needed is a soft wood component that is suitable for use as a central core for building structures that is strong and has dimensional stability as well as being light weight and includes the ability to properly interact with various adhesives and secure various fasteners.

### SUMMARY OF THE INVENTION

The present invention provides a building structure such as, for example, a door or window jamb, having outer solid wood members secured together around a LSL core (laminated strand lumber). The LSL core is a mixture of dried white wood fibers having a uniform moisture and density. The LSL core remains within dimensional and tolerance requirements.

The LSL multi-directional placement of wood fiber allows for a uniform binding of wood composite components to all flat surfaces.

The multidirectional wood fibers of the LSL core allows for any change in moisture content causing shrinkage or swelling in all directions reducing twisting or cupping.

The LSL core has a lesser weight per volume than veneer products thereby reducing the weight of the finished product. This allows the finished product to be easier to handle and move to the point of installation within the building.

The multi-directional fibers of the LSL core allows for greater screw holding capabilities and carrying ability than prior core products.

The LSL core of the present invention provides a product that is cost effective, strong, dimensionally stable, and attractive in its finished form.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a sectional view of wall cap having a LSL central core in accordance with the invention;

FIG. 2 is a sectional view of a paint grade frame having a LSL central core in accordance with the invention;

FIGS. 3A, 3B, and 3C are sectional views of a door frame, a relite frame, and a door/relite jamb, respectively, all of which have LSL central cores in accordance with the invention;

FIGS. 4A and 4B are sectional views of a relite frame and a relite mullion, respectively, both having LSL central cores in accordance with the invention; and

FIG. 5 is a sectional view stile and rail doors.

### DETAILED DESCRIPTION OF PREFERRED EMBODIMENTS

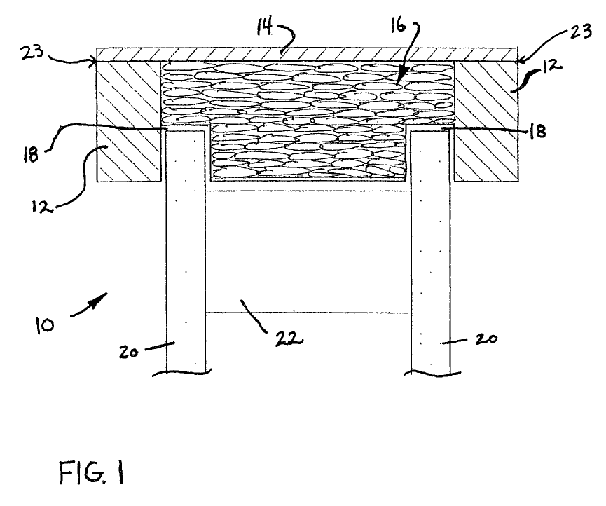

FIGS. 1, 2, 3A, 3B, 3C, 4A, 4B, and 5 show various embodiments of building structures in accordance with the present invention, including central cores of laminated strand lumber (LSL), which is a mixture of dried white wood fibers and bonding adhesive compressed into a solid block. The examples used in these figures relate primarily to commercial or institutional building environments but it should be understood that the present invention is not limited to such environments.

FIG. 1 is a sectional view of a wall cap 10 in accordance with the invention that is used, for example, to frame windowless openings in doors or walls. The wall cap 10 consists of side edges 12 and a face 14 that are adhesively secured together around and to a central core 16. The central core 16 is made of LSL cut to a desired length and machined to include spaces 18 to accommodate sheet rock 20 and a stud or header 22. The side edges 12 and face-14 are solid wood panels to give the wall cap 10 the appearance of being made of solid wood. The side edges 12 and face 14 form seams 23 therebetween where they meet along corners of the central core 16. The appearance of the seams 23 is minimized by finishing of the side edges 12 and face 14 panels during manufacture of the wall cap 10, for example, by sanding the surface of the core 16 and side edges 12 before adhering the face 14 so that the core 16 and side edges 12 are flush. The outer surfaces of the side edges 12 and face 14 may then be further finished to enhance the appearance of the finished wall cap 10 and to further reduce the appearance of the seams 23.

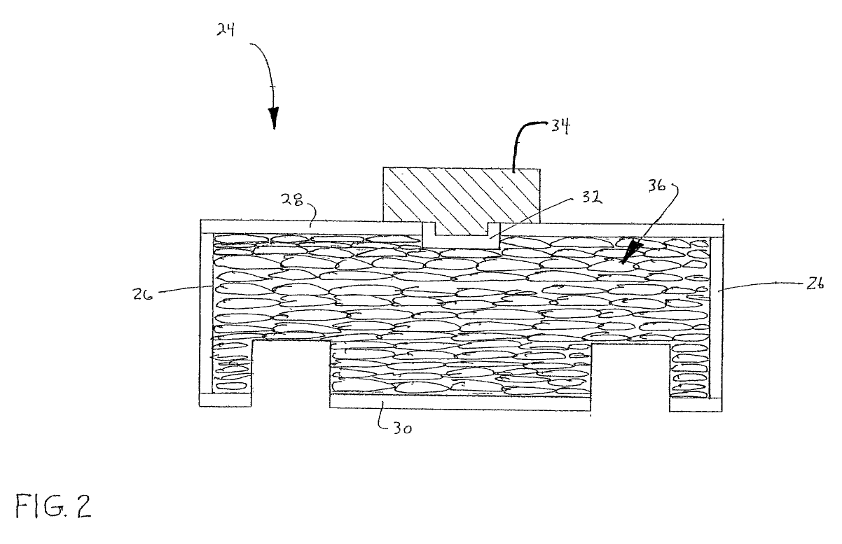

FIG. 2 is a sectional view of a paint grade frame 24 including a central LSL core 36 in accordance with the invention. A paint grade frame is one in which the stability of solid wood is desired but which will be painted allowing a lesser quality of wood to be used. The paint grade frame 24 has side edges 26 with front and back faces 28 and 30 of solid lower grade wood. The front face 28 includes an opening 32 to accomimodate a door stop 34. The side edges 26 and front face 28 are adhesively secured around and to the core 36 and finished as in the wall cap 10 of FIG. 1.

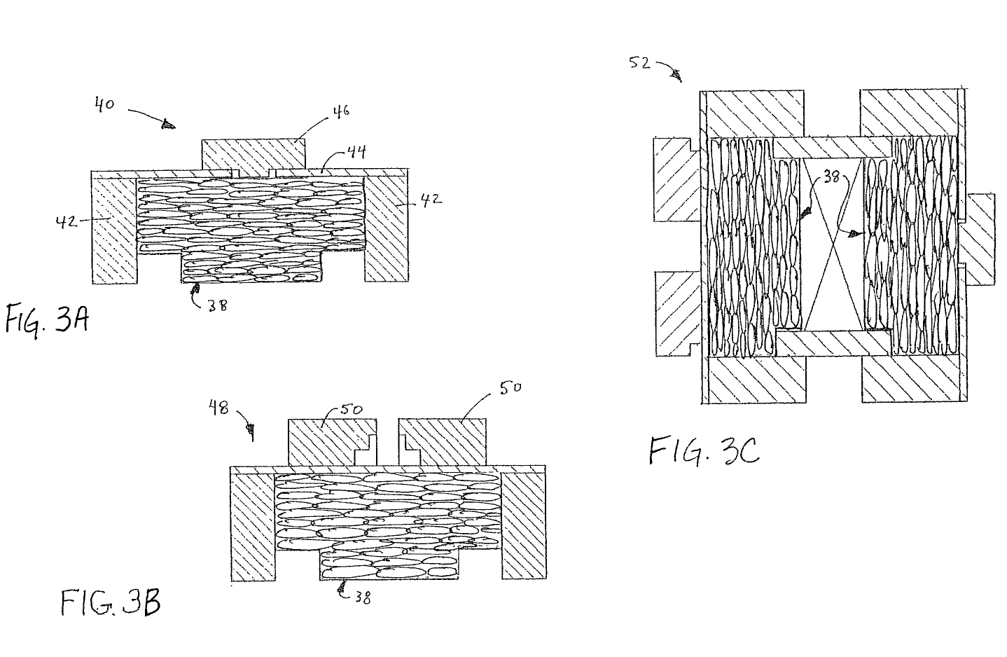

FIG. 3A is a sectional view of a door frame 40 similar to that shown in FIG. 2 including a LSL central core 38, side edges 42, a front face 44, and a door stop 46, which may include a lower grade wood intended to be painted or a higher grade wood that would not be painted. FIG. 3B is a sectional view of a relite frame 48 with glass/window stops 50 to hold a glass pane or other member such as, for example, a wood panel. FIG. 3C is a sectional view of a combination door/relite jamb 52 which is essentially a combination of a door frame and a relite frame of FIGS. 3A and 3B.

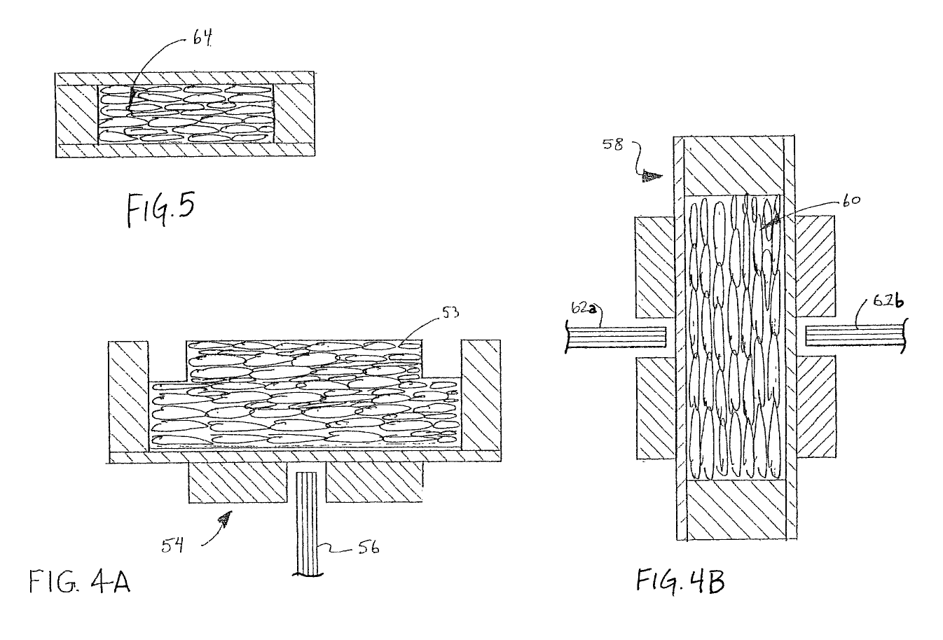

FIG. 4A is a sectional view of a relite frame 54 in accordance with yet another embodiment of the invention, which supports a relite member 56 such as, for example, a glass pane. The relite frame 54 includes an LSL core 53. FIG. 4B is a sectional view of a relite mullion 58 including an LSL core 60 in accordance with the invention, which supports adjacent glass panes 62a and 62b.

FIG. 5 shows a sectional view of a door rail or stile including an LSL core 64.

It will be obvious to those having skill in the art that many changes may be made to the details of the above-described embodiments of this invention without departing from the underlying principles thereof. The scope of the present invention should, therefore, be determined only by the following claims.

1. In building structure for framing doors, windows, relite and windowless openings in a wall, the building structure adapted for mounting to an edge of the wall, the building structure comprising:
a central core of laminated strand lumber that includes a compressed mixture of dried multidirectional white wood fibers and bonding adhesive, the laminated strand lumber having substantially uniform density and moisture content, the central core including a mounting side and multiple outer sides, the mounting side having one or more spaces machined therein for fitting the building structure to the edge of a wall; and
a plurality of thin solid wood panels adhered to the outer sides of the central core, the solid wood panels abutting each other where the outer sides meet to thereby form seams, the solid wood panels and the outer sides being finished to reduce the appearance of the seams.

2. The building structure of claim 1 in which the wall includes a pair of sheetrock panels and the spaces in the central core are sized to accommodate edges of the sheetrock panels.

3. The building structure of claim 1 in which the building structure is selected from the group consisting of:
(a) a wall cap;
(b) a door frame;
(c) a relite frame;
(d) a window frame; and
(e) a relite mullion.
